(19) United States
(12) Patent Application Publication
(10) Pub. No.: US 2005/0167376 A1
(43) Pub. Date: Aug. 4, 2005

(54) Merchandise display apparatus

(76) Inventor: Ralph C. Carter, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/770,340

(22) Filed: Feb. 2, 2004

(51) Int. Cl. B42F 1/00

(52) U.S. Cl. 211/59.1

(57) ABSTRACT

An apparatus can display merchandise in a retail setting. The apparatus can be an elongated strip made of a flexible material and is configured such that it can be removably held by a holder. The strip can have perforated sections that are adapted to receive prongs therethrough to removably attach a merchandise holding hook. The holder has an elongated slot at one end and a closed bottom end at the other end and a face opening therebetween. When the strip is held in the holder, the strip can have a face with an advertisement related to merchandise held on the hook. The advertisement can be readily seen through the face opening of the holder. The holder can be attached to various structures in a retail setting while holding the strip.

### BACKGROUND OF THE INVENTION

1. Field of the Invention

This invention relates to methods and devices for displaying items. More specifically, this invention relates to methods and devices for displaying items such as hats in retail settings.

2. Background of the Invention

Space is a premium commodity in the retail industry. Every inch of unused floor or wall space costs the retailer money in lost opportunity. Accordingly, it is important that retailers use as much store space as possible to sell merchandise. However, cluttered and unorganized merchandise can lead to consumer frustration in finding their desired merchandise and worsen the shopping experience, possibly leading to missed sales. Further, consumers are less likely to purchase sale items if the items are not displayed so as to be readily seen. An organized store that is fully stocked gives consumers a sense of choice and satisfaction while shopping. Additionally, organization of sale items decreases shopper frustration in finding the item they desire, thus improving the shopping experience. Thus, it is important for a retailer to be able to display as much product as possible while maintaining a neat and orderly display environment.

### SUMMARY OF THE INVENTION

This invention relates to apparatus and methods for displaying articles. Typically, these articles are for sale in stores. Exemplary articles include clothing, accessories, hats, key chains, and the like.

One embodiment of the invention, the apparatus comprises an elongated member made of cardboard, plastic or another flexible and light material. The member is advantageously a strip configured to be readily attached to conventional displays used in retail stores, such as display racks and display cabinets. In some embodiments, the strip has perforated sections, holes, or the like adapted to receive connectors therethrough to attach the strip to said conventional displays. In other embodiments, the strip is attached to said displays with adhesives. Advantageously, the strip is adapted to display product advertisements, so that consumers can view details about the products displayed on the strip.

Some embodiments include a holder adapted to receive a strip, as described above. For example, one embodiment of the holder has an elongated shape defining a longitudinal slot having an open end at the top of the holder and a closed end at the bottom of the holder, wherein the slot is configured to receive the strip. In other embodiments, the holder receives the periphery of the strip. In some embodiments, the holder also comprises at least one connector configured to attach the holder to a display rack or cabinet.

In one embodiment, the apparatus is configured to display hats. For example, the apparatus can be a strip having at least one display hook removably attached thereto. Optionally, the display hooks can be adapted to mount the strip to the display rack or cabinet. In one embodiment, each display hook can be adapted to receive a plurality of hats thereon. The apparatus also preferably has a top display area at its upper end. In one embodiment, this top display area is an outline of a human head configured to receive an item such as a hat being offered for sale.

In one embodiment, the display hook can have an backing plate and a pair of prongs, which are sized to pass through perforated sections of the strip and are coupled. The prongs can be coupled to the backing plate and can have an elongated section that pass through the perforated sections such that the strip is between the elongated portions and the backing plate. Further, the display hook can have a rail which is coupled to the backing plate and has one angled end to inhibit the movement of merchandise connected to the rail. In one embodiment, the rail is configured to receive and hold a hanger that is connected to merchandise.

A feature of the preferred embodiment described is that the apparatus need not intrude upon counter or wall space within the retail establishment. Moreover, the embodiments provide advertising space which does not intrude space in the store, which would otherwise not be used for displaying merchandise offered for sale.

Another feature of the preferred embodiment is that the apparatus is formed on a long, slender strip to provide an attention getting and visually appealing advertisement that supports products for sale. These strips advantageously use store place in which goods for sale are not ordinarily displayed. The customer is thus offered a very eye catching display of merchandise in areas of the store not typically associated with displaying articles for sale.

### BRIEF DESCRIPTION OF THE DRAWINGS

FIG. 1 is a perspective view of a plurality of hooks that are coupled to an elongated strip, which is held by a holder;

FIG. 1A is a perspective view of the end cap display rack in a retail setting;

FIG. 2 is a front view of the elongated strip shown in FIG. 1 having a plurality of perforated sections;

FIG. 3 is a back view of the elongated strip shown in FIG. 1 having a stiffener;

FIG. 4 is a perspective view of the holder as shown in FIG. 1;

FIG. 5 is a perspective view of a hook that can be coupled to an elongated strip;

FIG. 5A is a perspective view of a hook that can be coupled to an elongated strip;

FIG. 6 illustrates the hook shown in FIG. 5 coupled to an elongated strip;

FIG. 6A is a cross-sectional view of a strip held in a holder and coupled to a hook;

FIG. 7 is top view of the holder shown in FIG. 1;

FIG. 8 is a cross-sectional view of the holder shown in FIG. 7 holding a strip; and

FIG. 9 is a front view of a plurality of hooks and a hat disposed on a head of a strip, which is held by a holder.

### DETAILED DESCRIPTION OF THE PREFERRED EMBODIMENTS

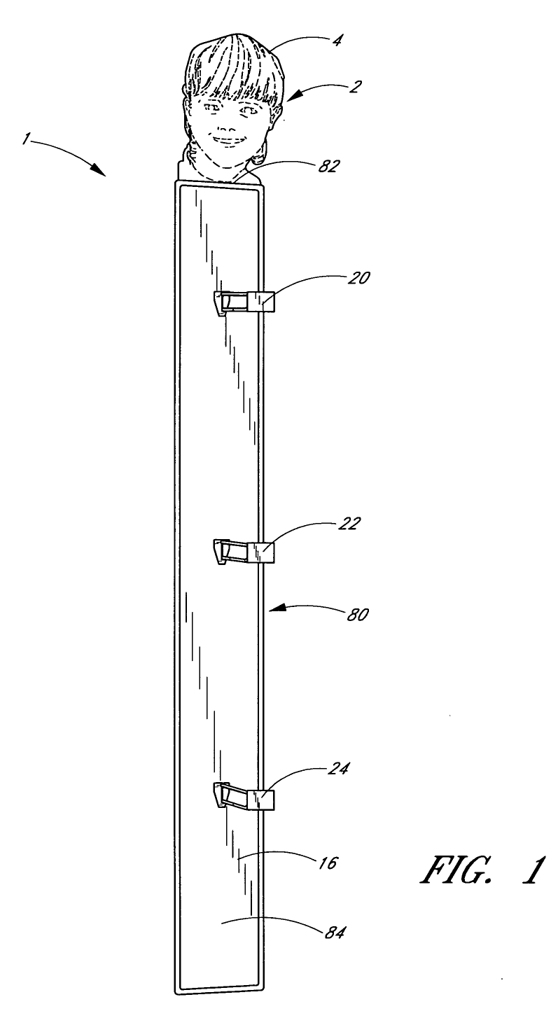

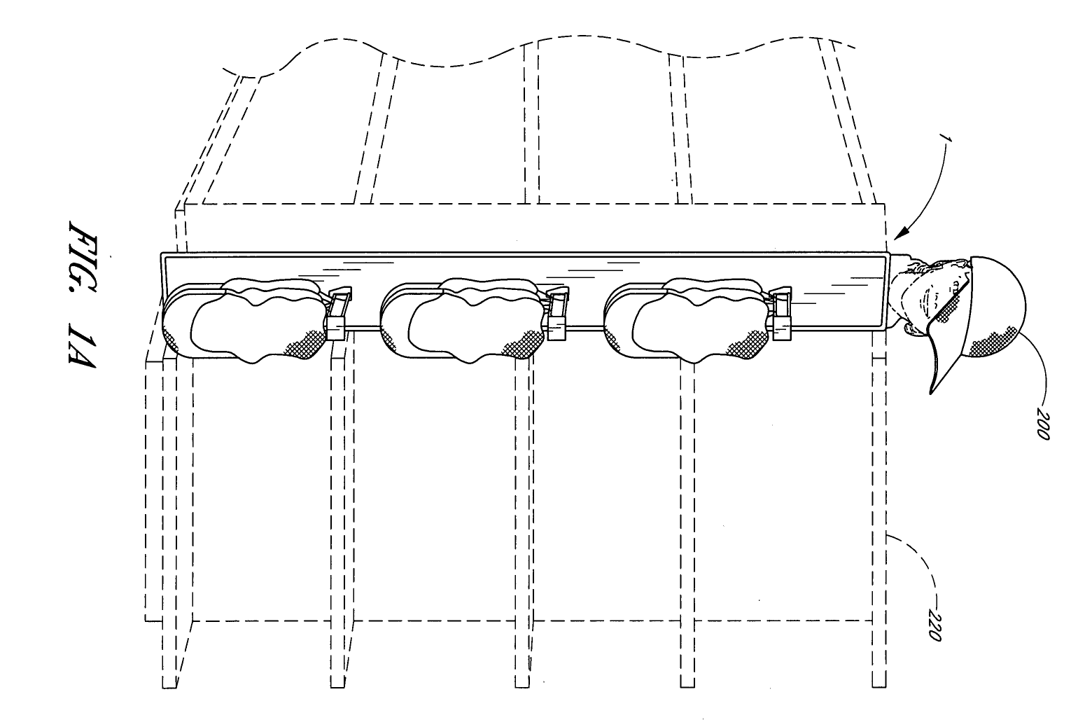

FIG. 1 illustrates an end cap display rack 1 having a plurality of merchandise display hooks 20, 22, and 24 that are removably coupled to an elongated strip 2, which is held within a holder 80. The plurality of merchandise display hooks 20, 22, and 24 each have one end removably coupled to the strip 2. The hooks 20, 22, and 24 are generally spaced apart along the vertical axis of the elongated strip 2 and are substantially perpendicular to a front face 16 of the strip 2. The strip 2 has a top display or head portion 4 extending above an elongated slot 82 of the holder 80 and a generally rectangular body 23 (shown in FIG. 2) with a outer periphery held within the holder 80. The strip 2 has the front face 16 that is visible through a front opening 84 of the holder 80. As illustrated in FIG. 1A, the end cap display 1 is attached to a shelving unit 220 and provides advertising space which does not intrude space in the store, which is typically not used for displaying merchandise offered for sale. The strip 2 provides an attention getting and visually appealing advertisement that supports products, such as hats, for sale.

FIG. 2 illustrates the strip 2 with a plurality of mounting or perforated sections 10, 12, and 14 for removably coupling the display hooks 20, 22, and 24 as shown in FIG. 1. The elongated strip 2 has the generally rectangular body 23 having a pair of vertical edges 13 and 15 extending from a strip bottom 6 to the head 4. Preferably, the length of the strip 2 is ranges from about 66.0 inches to about 67.5 inches and the length of the vertical edges 13 and 15 range from about 56 inches to about 59 inches. The width of the body 23 ranges from about 4.75 inches to about 7 inches, more preferably about 6 inches to about 7 inches. In one embodiment, for example, the body has a width of about 6.5 inches and the strip 2 has a length of about 66.75 inches. Advantageously, the aforementioned sized rectangular body 23 can be received and held within many conventional end cap displays or holders. The head 4 is attached to the top portion of the body 23 and is preferably generally shaped like an outline of a human head sized to fit within a cap or hat 200, as shown in FIG. 1A. Thus, a cap (e.g., a conventional baseball cap) can be placed on top and worn by the head 4 to increase the sales of merchandise. Further, a depiction or picture of a person's face can be located on the portion of the front face 16 disposed on the head 4. The front face 16 can also have an advertisement, preferably an advertisement that is related to the merchandise held on the hooks 20, 22, and 24. Preferably, the front face 16 has an attention getting and visually appealing advertisement that is readily visible through the front opening 84 of the holder 80.

The elongated strip 2 is made of flexible material for convenient attachment of the plurality of hooks 20, 22, and 24, while also being capable of holding the hooks 20, 22, and 24 displaying merchandise when the strip 2 is mounted in the holder 80. Preferably, the strip 2 inhibits movement of the hooks 20, 22, and 24, even when a plurality of hats or caps are place on the hooks. For example, the strip can have a thickness in the range of about 0.02 inch to about 0.06 inch, preferably about 0.04 inch, such that the strip 2 can support the hook 20 when the edges 13, 15 are held by the holder 80. Hooks attached to conventional signs may move an undesirable amount when loaded with merchandise because the conventional sign may tear or bend an undesirable amount. Advantageously, the strip is formed of material, such as plastic (e.g., polyethylene), that can prevent substantial movement of the hooks without tearing. Additionally, the strip 2 can advantageously be rolled up for convenient shipping and storage.

Each perforated section has a pair of holes that are configured to receive a portion of the hooks 20, 22, and 24, such that merchandise can be mounted to the hooks 20, 22, and 24 (shown FIG. 1). The distances between the perforated sections 10, 12, and 14 can be varied depending on the size and type of merchandise attached to the hooks 20, 22, and 24. Preferably, the sections 10, 12, and 14 are vertically spaced so that retail merchandise placed on the hooks does not substantially overlap. For example, retail merchandise in the form of hats can be placed on the hook 20, 22, and 24 such that the hats held by hook 20 will not substantially overlap and contact the hats on the hook 22 or the hook 22 itself. Similarly, hats held by the hook 22 will not substantially overlap and contact the hats on the hook 24 or the hook 24 itself. Thus, hats can be easily and conveniently removed from the hooks 20, 22, and 24. Of course, the perforated sections 10, 12, and 14 are distanced from the edges 13 and 15 so that the hooks 20, 22, and 24 can be conveniently mounted to the strip 2. In the illustrated embodiment, for example, the perforated section 10 has a hole 11A and a hole 11B that are generally equidistant from both the strip bottom 6 of the strip 2 and the longitudinal axis of strip 2. The holes 11A and 11B have a diameter in the range of about 0.2 inches to 0.3 inches, more preferably about 0.25 inches. Additionally, the center of holes 11A, 11B are preferably about 2 inches apart. Similarly, the perforated sections 12, 14 have a pair of holes that are generally horizontal and centered about the longitudinal axis of the strip 2. Of course, those of ordinary skill in the art recognize that the strip 2 can have one or more mounting or perforated sections, each configured to mount a merchandise displaying hook. For example, in one embodiment, the strip 2 can have four perforated sections, each configured to mount a hook (e.g., the hook 20).

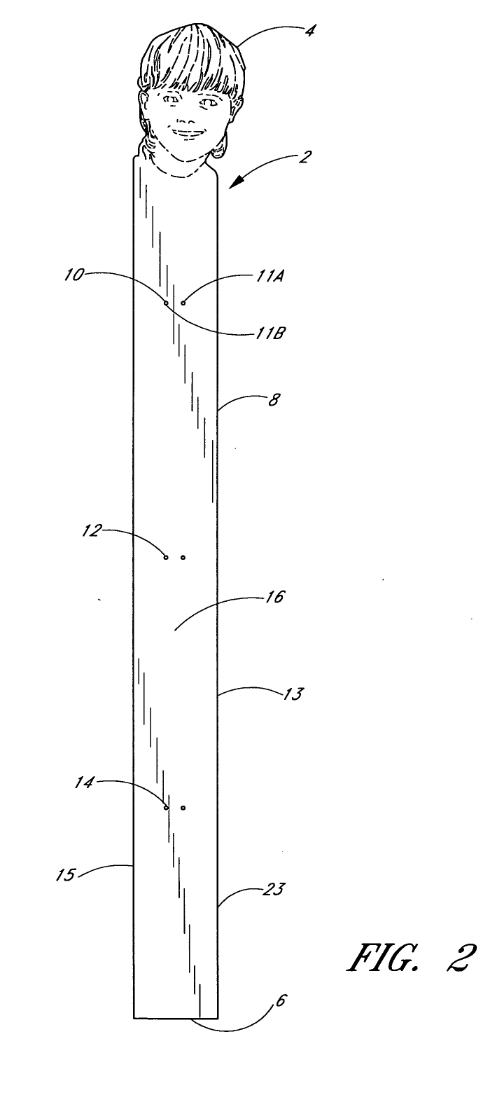

FIG. 3 illustrates the elongated strip 2 having a vertical support or stiffener 81 coupled to a back face 18 and the plurality of perforated sections 10, 12, and 14. The stiffener 81 extends from the top region of the body 23 above the perforated section 10 to the lower portion of the head 4 and is preferably aligned along the longitudinal axis of the strip 2. Because the stiffener 81 provides structural support to the head 4, the head 4 does not substantially move out of the plane defined by the elongated strip 2 when a hat or cap is placed upon the head 4. In the illustrated embodiment, the stiffener 81 is a thin, narrow rectangular strip that can be made of wood, metal, or the like that can be coupled to the strip 2 in various manners, such as by using fasteners, adhesives, or the like. Thus, a hat can be placed upon the head 4 because the stiffener 81 provides sufficient support to the neck portion of the head 4 to prevent the buckling or substantial movement of the strip 2.

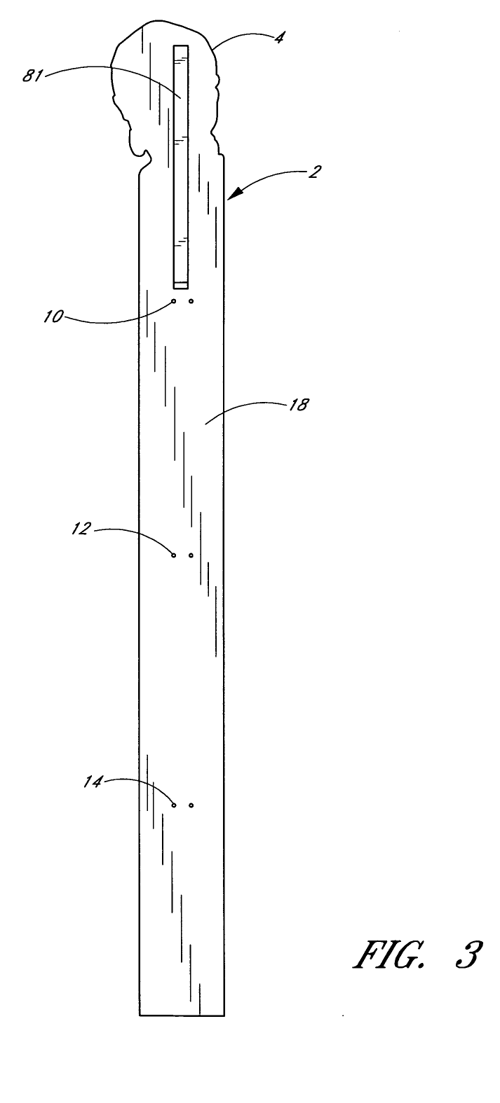

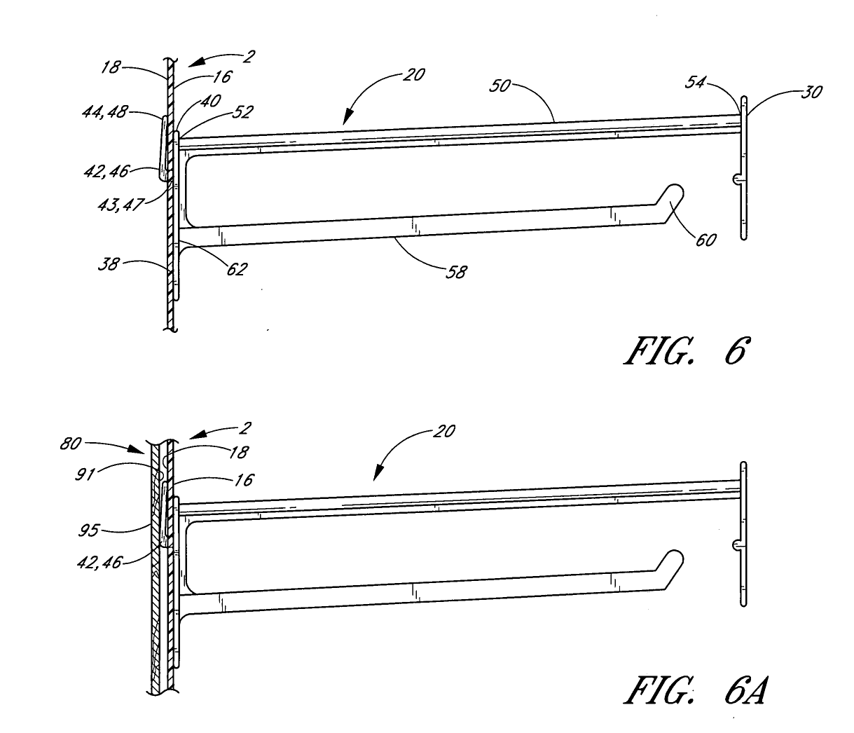

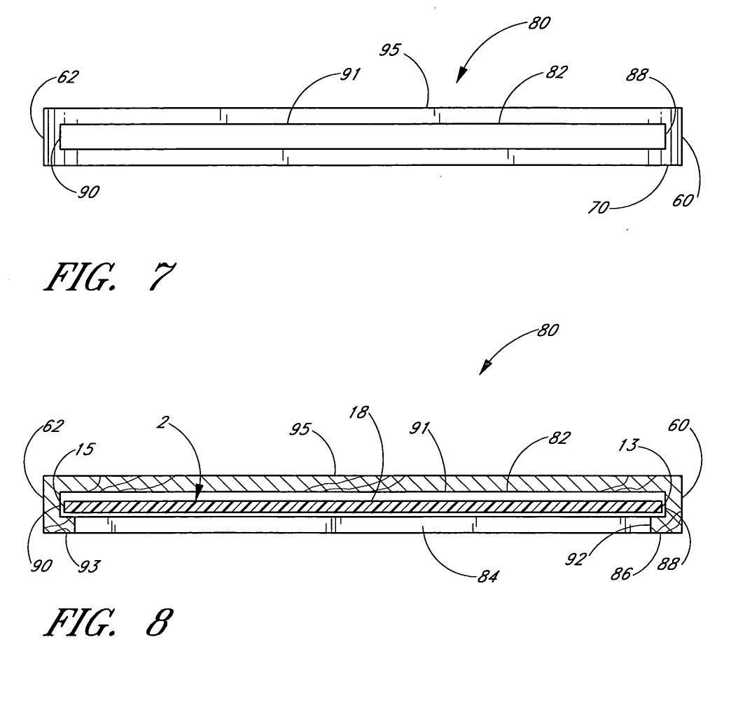

FIG. 4 illustrates the holder 80 having a top end 76 at one end and a holder bottom 78 at the other end and a pair of vertical sides 60 and 62 therebetween. The top end 76 has the elongated slot 82 that is sized so that the elongated strip 2 can be pass through and be surrounded by the slot 82. That is, the slot 82 has a width and length that are greater than then thickness and width of the strip 2. In one embodiment, one end of slot 82 is sized and shaped similarly to a groove 88, while the other side of slot 82 is sized and shaped similar to the groove 90 as shown in FIG. 7 and FIG. 8. A back 95 and a front face 91 are disposed on one side of the slot 82 and have generally rectangular shape and extend from the top end 76 to the bottom end 78. Further, the back 95 is wider than the body 23 of the strip 2 because flanges 92 and 93 are attached to the edges of the back 95, which is configured so that a mounting fixture or adhesive can couple the back 95 to display shelves, units, walls, mounting surface, or the like. For example, a screw can pass through the front face 91 and the back 95 and attach the holder 80 to the mounting surface. In another embodiment, the back 95 has a substantially flat surface so that a secure bond can be formed between the holder 80 and the mounting surface by using an adhesive. The holder 80 can be formed from plastic, metal, or the like. For example, in one embodiment, the holder 80 is formed from sheet metal.

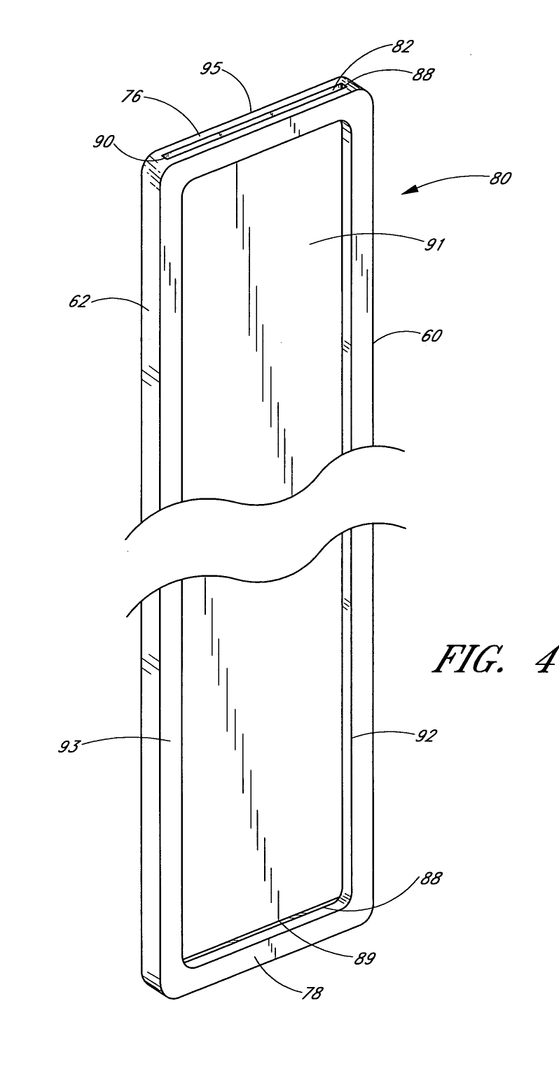

FIG. 5 is a perspective view of the hook 20 comprising an insertion end 40, a stopper 30, and a pair of rails 50 and 58 therebetween. The insertion end 40 has a pair of generally L-shaped prongs 42 and 46 that are configured to removably mount the hook 20 to the strip 2. The rails 50, 58 have one end that is attached to the insertion end 40, and the other end of the rail 50 is attached to the stopper 30.

The prong 42 has an vertically elongated portion 44 and a lower portion 43 that is connected to a backstop 39. The prong 46 has a vertical elongated portion 48 and a lower portion 47 that is connected to the backstop 39. The vertical portions 44, 48 have substantially rectangular cross-sectional profiles and are generally parallel and configured such that they can be received by the perforated section, such as the section 10. For example, the distance between the center of the holes 11A and 11B can be the same the distance from the longitudinal axis of the elongated portion 44 and 48. Further, the prongs 42 and 46 are sized to so that they can pass through the pair of holes in the perforated section 10 in order to mount the hook 20 to the strip 2.

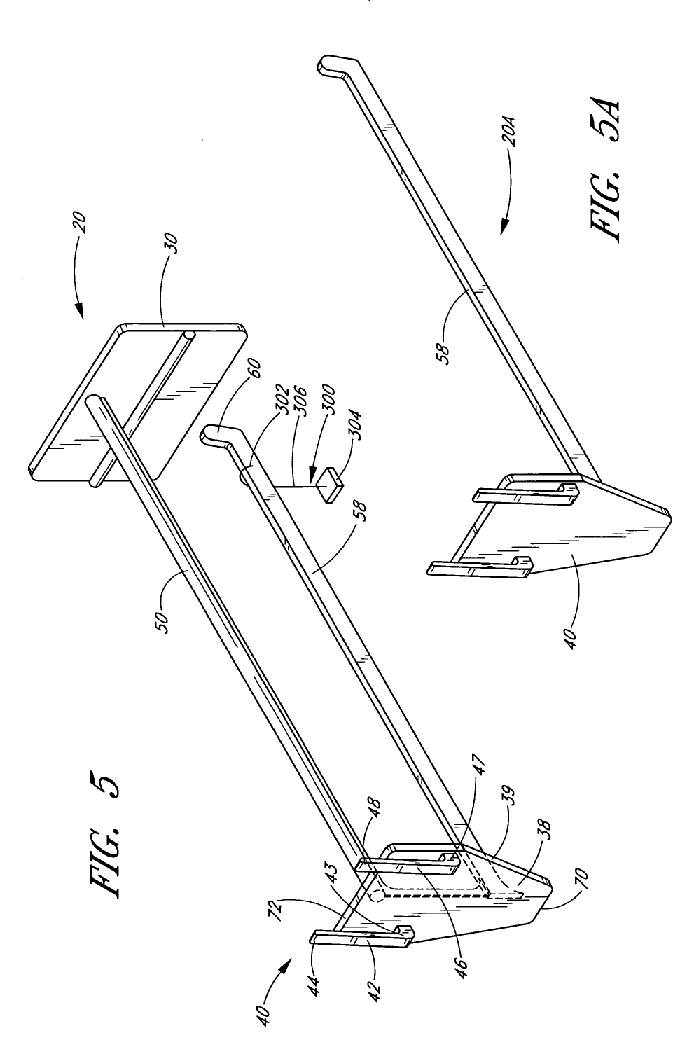

One end of the rail 50 is attached to the backstop 39 and the other end holds the stopper 30. In the illustrated embodiment, the rail 50 is a rod having a substantially uniform cross-sectional profile and can help prevent merchandise from falling off the rail 58. The rail 58 is below the rail 50 and is shorter than the rail 50. One end of the rail 58 is attached to the backstop 39 and the other end has an angled tip 60, which is near the stopper 30. The rail 58 is sized so that merchandise can be held on the rail 58 and/or slid along the rail 58. The angled tip 60 can prevent merchandise from sliding off the rail 58 in the horizontal direction. The rail 58 can hold a plurality of hats or similar merchandise, preferably without substantial movement of the tip 60 in the vertical direction. The rail 58 can be configured so that when merchandise is held by the rail 58, the rail 58 is generally perpendicular to the backstop 39. The stopper 30 is generally rectangular and can be perpendicular to the rail 50. As shown in FIG. 6, the stopper 30 extends from one end of the rail 50 past the longitudinal axis of the rail 58. The stopper 30 provides a surface that can help prevent injury when a person contacts the hook 20.

The hook 20 can be made of various materials, such as plastic or metal, and can be integrally formed. For example, the hook 20 can be formed of plastic through an injection molding process. Alternatively, the hook 20 can be made of various components. In one embodiment, one end of the rail 50 and the rail 58 can be inserted into and fastened to the insertion end 40, and the stopper 30 can be fastened to the rail 50. Those skilled in the art recognize that there are various hooks that can be removably coupled to the strip 2. For example, FIG. 5A illustrates a hook 20A having the rail 58 connected to the insertion end 40.

FIG. 6 illustrates the hook 20 removably coupled to a portion of the elongated strip 2 so that the pair of rails 50, 58 are extended from the elongated strip 2. The lower portions 43, 47 of the prongs pass through the pair holes (e.g., the hole 11A and 11B) of the elongated strip 2, while the strip 2 is between the prongs 42 and 46 and the backstop face 38. Thus, the strip 2 is held between both the elongated portions 44 and 48 and the backstop face 38, thereby inhibiting movement of the hook 20 relative to the strip 2. That is, the strip 2 can be securely held between the backstop face 38 and the prongs 42 and 46. Preferably, the thickness of the strip 2 is substantially similar to the distance between the elongated portions 44, 48 and the backstop 39. FIG. 6A illustrates the hook 20 attached to the strip 2, which is held by the holder 80.

FIG. 7 is a top view of the holder 80 having the elongated slot 82 for receiving the strip 2. The slot 82 has a generally rectangular shape and is sized so that the strip 2 can easily be slid into and out of the holder 80.

FIG. 8 is a cross-sectional view of the holder 80 having the pair of opposing grooves 88 and 90 that can receive and inhibit movement of the strip 2. The groove 88 is at one side of the holder 80, while the groove 90 is at the other side. The groove 88 is disposed between the flange 92, which extends along the inner periphery of the vertical side 60, and the front face 91. The groove 90 is disposed between the flange 93, which extends along the inner periphery of the vertical side 62, and the front face 91. The grooves 90 and 88 are configured to hold the outer periphery of the strip 2, preferably slidably engaged to the outer periphery of the body 23 of the strip 2. Those skilled in the art recognize that the holder 80 can be a conventional advertisement holder used retail stores.

The front opening 84 is defined by a periphery face 86, which is formed by a portion of the flanges 92 and 93. The groove 88 is between a flange 92 and the front face 91, and the groove 90 is between the flange 93 and the front face 91, as described above. The pair of grooves 88 and 90 are generally U-shaped and are configured to receive the edges 13 and 15 of the strip 2, and preferably extend from the top end 76 to the bottom end 78 of the strip 2. The grooves 88 and 90 can have a substantially similar profile which is uniform between the top end 76 and the bottom end 78. Further, the grooves 88 and 90 can have a substantially constant cross section with a width greater than the width of the strip 2 so that the edges 13 and 15 of the strip 2 can be easily and conveniently slide along the grooves 88 and 90, respectively. When the strip 2 is placed in the holder 80, the pair of grooves 88 and 90 inhibit movement of the strip 2 by holding the edges 13 and 15. Those skilled in the art will recognize that there are many different configurations of holder 80 that can hold the strip 2. As can be seen in FIG. 4 there can be a groove 89 on the inner periphery of the bottom end 78 that can receive the strip bottom 6. Thus, the outer periphery of the body 23 can be held within the grooves 88, 90, and 89 of the holder 80. Thus, when the strip 2 is held by the holder 80, the outer periphery of the strip 2 is between the front face 91 and the periphery face 86, which defines the front opening 84 permitting shoppers to see the front face 16 and the head 4 of the strip 2.

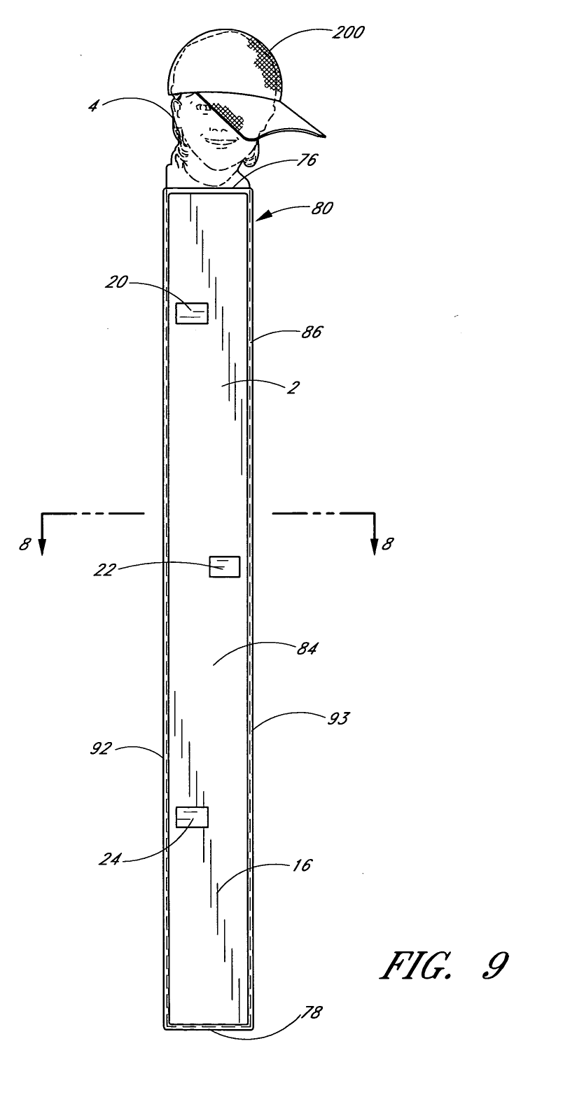

FIG. 9 illustrates the elongated strip 2 held within the holder 80 with the plurality of hooks 20, 22, and 24 disposed on either side of the longitudinal axis of the strip 2. The holder 80 has the periphery face 86, which vertically extends from the top end 76 and the bottom end 78 and horizontally extends between the vertical edges 60 and 62. The periphery face 86 has a pair of vertical sides formed by a portion of the flanges 92 and 93. The periphery face 86 defines the front opening 84, preferably a generally rectangular shaped opening, that a shopper can see through to see the front face 16 of the strip 2. Thus, the front face 16 of the strip 2 can have an various advertisements that can be see through the front opening 84. Preferably, the strip 2 has the head 4 shaped like an outline of a person's head. The head 4 is located above the holder 80 and has a advertisement on the its face. A hat 200 is located on the top of the head 4 to increase shopper's desire to purchase merchandise held on the end cap rack display 1.

In operation, the strip 2 can be placed in the holder 80 by holding the elongated strip 2 above the holder 80 and inserting the strip bottom 6 of strip 2 into the slot 82. The strip bottom 6 passes through the slot 82 towards the holder bottom 78 of the holder 80. The pair of edges 13 and 15 of the strip 2 slide along the grooves 88 and 90, respectively, as the strip 2 is moved vertically downward relative to the holder 80. The strip 2 is slide into the holder 80 so that the bottom 6 is received by the groove 89. In other words, the edges 13, 15 of the strip 2 slide along the grooves 88, 90, respectively, while the strip 2 is moved in the downward direction. Once the strip bottom 6 is within the groove 89, the outer periphery of strip 2 is held within the holder 80, and the head 4 extends above the holder 80. As discussed above, the hat 200 can be placed and worn by the head 4 (shown in FIGS. 1A and 9) because the lower portion of the stiffener 81 can pass through the slot 82 and can be disposed between the front face 91 and the strip 2 to thereby inhibit movement of the heat 4. Thus, shoppers can see the eye catching advertisements on the front face 16, which can be seen through the front opening 84, and on the face of head 4. The strip 2 can, of course, be removed from the holder 80 by moving the strip bottom 6 away from the holder bottom 78. That is, the strip 2 is moved in the upward direction so that the strip 2 passes through the slot 82. The pair of edges 13, 15 can slide along the grooves 88, 90, respectively, as the strip 2 is moved vertically out of the holder 80 until the strip bottom 6 passes through the slot 82. The strip 2 can be changed periodically because the strip 2 can be easily and conveniently inserted and removed from the holder 80. Thus, the retailer can use the same holder 80 to hold one of various strips 2, which can both advertise and display merchandise for sale.

The plurality of hooks 20, 22 and 24 can be removably coupled to the strip 2, preferably after the elongated strip 2 has been inserted into the holder 80. For example, the hook 20 is removably coupled to the elongated strip 2 by inserting the ends of the elongated potions 44 and 48 into a pair of holes (e.g., the holes 11A and 11B) in the strip 2. The elongated potions 44 and 48 are then passed through the pair of holes until the lower portions 43, 47 of the pair of prongs extend through the pair of holes. Once the lower portions 43, 47 reach the pair of holes, the hook 20 can be moved toward the strip 2 so that the backstop face 38 contacts the strip 2. In other words, the hook 20 is removably coupled to the strip 2 by having the top periphery of the holes 11A, 11B located between the ends of the elongated portions 44, 48 and the backstop 39. The top periphery of the holes 11A, 11B can then be moved toward the lower portions 43 and 47. When the top periphery of the holes 11A, 11B contacts or is adjacent to the lower portions 43 and 47, the insertion face 39 can be moved toward the strip 2 so that the backstop face 38 contacts the front face 16 of the strip 2. As shown in FIG. 6, the strip 2 is held between the backstop 39 and the elongated portions 44, 48 of the prongs 42, 46. Of course, the strip 2 is flexible to allow the prongs 42, 46 to pass through the pair of holes as described above. Preferably, the strip 2 is made of a resilient plastic that is not permanently deformed when the hooks are coupled to the strip. Of course, the hooks 22 and 24 can be removably coupled to the strip 2 in a similar manner. The plurality of hooks 20, 22, and 24 can be removed from the strip 2 by simply reversing the aforementioned steps.

As shown in FIG. 6A, when the hook 20 is coupled to the strip 2 held by the holder 80, the pair of prongs 42, 46 are between the strip 2 and the holder 80. In particular, the elongated portions 44, 48 are between the back face 18 of the strip 2 and the front face 91 of the holder 80. The holder 80 and strip 2 are sized and configured so that the pair of prongs 42, 46 can be received behind the strip 2 and securely held in place.

In the illustrated embodiment, after the strip 2 is securely mounted into the holder 80 and the hooks 20, 22, and 24 are inserted into the elongated strip 2, hats or other merchandise can be placed on the rail 58. Preferably, the merchandise may not fall off the hook 20 because strip 2 inhibits movement of the insertion end 40, thereby inhibiting movement of the rail 58. When the rail 58 is loaded with merchandise, the ends of the elongate portions 44, 48 may move away from the front face 91 but contacts the back face 18 of the strip 2. However, the linear movement of the lower portions 43, 47 may be substantially inhibited because the lower portions 43, 47 are preferably secured in the holes 11A and 11B.

The rail 50 and stopper 30 can prevent merchandise from being accidentally contacted and knocked of the rail 58. The rail 58 can be configured so that when the merchandise is attached to the rail 58, the merchandise will not slide along the rail 58 toward the tip 60, thereby preventing merchandise from falling off of the rail 58.

The hats or other merchandise can be directly mounted on the rail 58. Alternatively, there can be hangers or hooks that have one end coupled to the rail 58 and the other end coupled to the hats or other merchandise. Hangers or hooks can be attached to the merchandise and can be attached to the rail 58. In one embodiment, the hanger can be a conventional hanger with an opening for receiving the rail 58 and can be slide over the rail 58 without contacting the rail 50. Of course, these hooks or hangers may not slide off the rail 58 because the angled tip 60 inhibits the movement of the hanger along the rail 58.

There can be a variety of hangers that are commonly known that can used in combination with the plurality of hooks 20, 22, and 24. For example, there can be a hanger which is attached to the cap and has one end configured to be mounted on the rail 58. The other end of the hanger can be securely fastened to a portion of the hat. As illustrated in FIG. 5, a hanger 300 can be a convention hanger with a line connector 306 between a hook 302 sized to fit over the rail 58 and a T-end 300. The line connector 306 can pass through the fabric of the hat, which is disposed between the T-end 304 and the hook 302. In this manner, a plurality of hats can be disposed along the rail 58 on each of the plurality of hooks 20, 22 and 24 such that the hats, or other merchandise, do not substantially overlap and can be conveniently removed from the hook 20. Those skilled in the art recognize that there can be various numbers of hooks that can be attached to the strip 2.

While particular forms of the invention have been described, it will be apparent that various modifications can be made without departing from the spirit and scope of the invention. For example, although illustrated with only three perforated sections, it is commonly known that the strip 2 can have other amounts of perforated sections and in other configurations. Accordingly, it is not intended that the invention be limited, except as by the appended claims.

1. A merchandise display apparatus for providing an attention getting display of goods for sale in a retail establishment, said apparatus adapted to be used as an end cap of a store display fixture so that said merchandise display apparatus does not intrude upon counter or wall space within the retail establishment, said apparatus comprising:
a long, relatively narrow rectangular strip having an advertisement on a face thereof, the strip made of a flexible material, the strip further having a plurality of perforated sections, a top end of said strip generally defining an outline of a human head and is configured to receive retail merchandise thereon;
an elongated generally rectangular strip holder having a longitudinal slot therethrough with an open top end and a closed bottom end, a peripheral edge and an open front portion, said slot configured to receive the strip therethrough so that a majority of said strip is disposed between the peripheral edge and so the advertisement is visible through the front portion;
a plurality of merchandise holding members having an insertion end and a stopper end, the insertion end configured to be removably inserted through said perforated sections, the hooks having a rail configured to receive retail merchandise thereon, the stopper end configured to prevent said merchandise from inadvertently slipping off the hook; and
at least one connector configured to removably attach the holder to a support surface.

2. An apparatus for displaying goods for sale, comprising:
a long, relatively narrow generally rectangular strip made of a flexible material, the strip further having a plurality of perforated sections, a top end of said strip generally defining an outline of a human head and is configured to receive retail merchandise thereon;
an elongated generally rectangular strip holder having a closed bottom end, a pair of vertical edges and an open front portion, said holder configured to receive the strip so that a majority of said strip is disposed between the pair of vertical edges and so the strip is visible through the front portion; and
a plurality of merchandise holding members having an insertion end and a stopper end, the insertion end configured to be removably inserted through said perforated sections, the hooks having a rail configured to receive retail merchandise thereon, the stopper end configured to prevent said merchandise from inadvertently slipping off the hook.

3. The apparatus of claim 2, wherein each of the perforated sections comprises a pair of holes on either side of the longitudinal axis of the strip and are spaced such that the retail merchandise only contacts one merchandise holding member.

4. The apparatus of claim 3, wherein the merchandise is a hat configured to hang from the rail.

5. The apparatus of claim 2, wherein each perforated section comprises a pair of holes, and the insertion end of the merchandise holding member has a pair of prongs sized to pass through the pair of holes and a backstop to contact the strip.

6. The apparatus of claim 5, wherein the pair of prongs have an elongated portion, each of the hooks can be removably coupled to the strip when the pair of prongs pass through one of the perforated sections such that strip is between the elongated portions and the backstop.

7. A method for using space at the end of a store display fixture to call attention to merchandise offered for sale, comprising:
mounting an elongated generally thin, slender strip configured to be removably held at the end of a store display fixture;
mounting a plurality of elongated hooks having a rail between a mounting end and a stopper end, the rail configured to receive and hold thereon merchandise offered for sale, the mounting end configured to be removably coupled to the strip by passing a portion of the mounting end through a portion of the strip.

8. The method of claim 7, wherein the plurality of the elongated hooks are substantially perpendicular to the strip when the merchandise are held by the hooks.

9. The method of claim 7, wherein the rail comprises a first rod and a second rod, the first rod has one end that is coupled to the mounting end and another end coupled to the stopper end, the second rod is configured and sized to receive and hold a hanger that is connected to a hat, and the stopper end is configured to prevent the hanger from sliding off the hook.

10. The method of claim 7, wherein the portion of the mounting end has a pair of elongated prongs and the strip has a pair of holes configured to receive the prongs.

11. The method of claim 7, wherein the strip is substantially rectangular and has one end configured to fit within and hold a hat thereon, the strip has a front face with an advertisement.

12. The method of claim 7, wherein the mounting end has a pair of prongs coupled to a backing plate, the prongs and the plate configured so that the strip can be securely held between the prongs and the plate, when the strip is held within vertical sides of a strip holder the prongs are disposed between the strip and the holder.

13. The method of claim 7, further comprising placing a hat on an upper portion of the strip defining an outline of a human head.

14. A method of holding hats, comprising:
providing a generally flexible body configured to be removably and rigidly held by a holder, a plurality of holes passing through the flexible body; and
passing a pair of prongs of a hook through the holes of said flexible body such that said flexible body is between the pair of prongs and a backstop of said hook, the pair of prongs of the hook pass through the flexible body such that the body is between a substantial portion of the prongs and the backstop.

15. The method of claim 14, further comprising placing a hat on an upper portion of said flexible body shaped like a human head.

16. A retail display, comprising:
a generally rectangular flexible body is configured such that a pair of vertical edges of the body is held within a generally rectangular holder, which has a back face and a front opening and the pair of edges therebetween; and
a plurality of holes passing through said flexible body and configured to be removably coupled to a hook, which has a pair of prongs and a backstop, when the pair of prongs of the hook pass through the flexible body, the body is between a substantial portion of the prongs and the backstop.

17. The retail device structure of claim 16, further comprising a portion shaped like a human head coupled to the one end of the flexible body and is configured to receive a hat thereon.

18. The retail device structure of claim 16, wherein the flexible body has a thickness in the range of about 0.035 inch to about 0.045 inch and a width in the range of about 6 inches to about 7 inches and a length in the range of about 56 inches to about 59 inches.

19. The retail device structure of claim 18, wherein the flexible body is formed from plastic.

20. The retail device structure of claim 16, wherein the body has a front face having an advertisement thereon, the advertisement visible through the front opening of the holder when the body is held within the holder.

21. A method for displaying merchandise offered for sale, comprising:
mounting an elongated generally thin strip configured to be removably held at a store display fixture; and
mounting a plurality of elongated hooks having a rail, the rail configured to receive and hold thereon merchandise offered for sale, the hook having a mounting end configured to be removably coupled to the strip by passing a portion of the mounting end through a portion of the strip.

22. A retail display, comprising:
a generally flexible body is configured such that a pair of edges of the body is held within a holder, which has a back face and a front opening and the pair of edges therebetween; and
a plurality of holes passing through said flexible body and configured to be removably coupled to a hook, which has a pair of prongs and a backstop, when the pair of prongs of the hook pass through the flexible body, the body is between a substantial portion of the prongs and the backstop.
